(19) United States
(12) Patent Application Publication
(10) Pub. No.: US 2026/0277542 A1
(43) Pub. Date: Sep. 17, 2026

(54) SMART GLASSES, SMART GLASSES SYSTEM, AND STRESS RELIEF NOTIFICATION METHOD

(71) Applicant: SOLOS TECHNOLOGY (SHENZHEN) LIMITED, Shenzhen (CN)

(72) Inventors: Hoi Man Lau, Shenzhen (CN); Kwok Wah Law, Shenzhen (CN); Wai Kuen Kenny Cheung, Shenzhen (CN)

(21) Appl. No.: 19/685,117

(22) Filed: May 22, 2026

Related U.S. Application Data
(63) Continuation of application No. PCT/CN2024/086893, filed on Apr. 9, 2024.

(30) Foreign Application Priority Data
Apr. 14, 2023 (CN) 202310410362.7

(51) Int. Cl. G06F 3/16; G06F 3/01

(52) U.S. Cl. CPC G06F 3/167; G06F 3/012; G06F 3/013; G06F 3/165

(57) ABSTRACT

Smart glasses, a smart glasses system, and a stress relief notification method are provided. The smart glasses include a processor, a sensor, an input device and a playback device, all of which are provided in temples. The processor is used to continuously obtain sensing data of the sensor, and determine an eye-use state of a user according to the sensing data. The processor is further used to control the playback device to issue a rest notification when the eye-use state of the user satisfies a preset notification condition, and control the playback device to play a preset audio file when a preset input action performed by the user on the input device is detected within a preset waiting duration. The smart glasses, the smart glasses system, and the stress relief notification method can improve the intelligence of notification a user to take a rest through smart glasses.

### CROSS REFERENCE TO RELATED APPLICATIONS

This application is a Continuation Application of PCT Application No. PCT/CN2024/086893 filed on Apr. 9, 2024, which claims priority to Chinese Patent Application No. CN 202310410362.7, entitled “SMART GLASSES, SMART GLASSES SYSTEM AND STRESS RELIEF NOTIFICATION METHOD”, filed with the Patent Office of the China National Intellectual Property Administration on Apr. 14, 2023, which is hereby incorporated by reference herein as if set forth in its entirety.

### BACKGROUND

### 1. Technical Field

The present disclosure generally relates to the technical field of smart wearable devices, and in particular to smart glasses, a smart glasses system, and a stress relief notification method.

### 2. Description of Related Art

When people read, prolonged focused gazing at electronic screens or pages of physical books may result in excessive eye use, thereby causing health problems including binocular fatigue, headaches, shoulder and neck pain. Accordingly, various eye protection measures have been widely adopted in recent years to relieve visual problems and mental stress. For instance, the 20-20-20 eye protection rule can effectively protect eyesight; specifically, a person gazes at an object twenty feet away every twenty minutes for twenty seconds to relax the eye muscles.

In the prior art, smart glasses may be used to detect a user's eye-use distance and duration, issue alerts, and perform tracking and statistics. However, such technologies are generally applied to correct eye-use habits of children, prevent visual fatigue, and reduce the probability of myopia in children. Currently, there is no notification method in the industry for relaxing the eyes and mind of users in a working state.

### SUMMARY

Embodiments of the present disclosure provide smart glasses, a smart glasses system, and a stress relief notification method, which focus on solving the problem that users in a working state lack eye rest notifications to relieve eye fatigue and soothe their mood.

An embodiment of the present disclosure provides smart glasses, including:
a processor, a sensor, an input device and a playback device, all of which are provided in temples;
wherein the processor is connected with the sensor, the input device and the playback device;
the processor is used to continuously obtain sensing data of the sensor, and determine an eye-use state of a user according to the sensing data; and
the processor is further used to, in response to the eye-use state of the user satisfying a preset notification condition, control the playback device to issue a rest notification, and in response to a preset input action performed by the user on the input device being detected within a preset waiting duration, control the playback device to play a preset audio file.

An embodiment of the present disclosure further provides a smart glasses system including: a smart terminal, a cloud server, and the aforementioned smart glasses.

An embodiment of the present disclosure provides a stress relief notification method including: issuing the rest notification through the aforementioned smart glasses, and playing the preset audio file through the smart glasses in response to the smart glasses detecting the preset input action of the user.

It can be seen from the aforementioned embodiments of the present disclosure that the smart glasses in the present disclosure include a processor, a sensor, an input device and a playback device provided in temples. The processor is used to continuously obtain sensing data of the sensor, determine an eye-use state of a user according to the sensing data, control the playback device to issue a rest notification in response to the eye-use state of the user satisfying a preset notification condition, and control the playback device to play a preset audio file in response to a preset input action performed by the user on the input device being detected within a preset waiting duration. Accordingly, the automatic triggering of the rest notification and playing of audio files upon detection of the user's input action can be realized by monitoring the user's eye-use state, and the intelligence of the smart glasses and the convenience of user operation are improved.

### BRIEF DESCRIPTION OF THE DRAWINGS

In order to more clearly illustrate the technical solutions in the embodiments of the present disclosure, a brief introduction to the accompanying drawings used in the descriptions of the embodiments or the prior art will be given below. Obviously, the accompanying drawings described below are merely some embodiments of the present disclosure.

FIG. 1 is a schematic diagram of a hardware structure of smart glasses according to an embodiment of the present disclosure.

FIG. 2 is a schematic diagram of angles for determining an eye-use state of the smart glasses according to embodiments of the present disclosure.

FIG. 3 is another schematic diagram of angles for determining the eye-use state of the smart glasses according to embodiments of the present disclosure.

FIG. 4 is a schematic structural diagram of a smart glasses system according to an embodiment of the present disclosure.

FIG. 5 is a schematic flowchart of a stress relief notification method according to embodiments of the present disclosure.

### DETAILED DESCRIPTION

In order to make the objectives, technical solutions and advantages of the embodiments of the present disclosure clearer, the technical solutions in the embodiments of the present disclosure will be clearly and completely described below with reference to the accompanying drawings in the embodiments of the present disclosure. Apparently, the described embodiments are part of the embodiments of the present disclosure, not all of them. All other embodiments obtained by those skilled in the art based on the embodiments of the present disclosure without creative efforts shall fall within the scope of protection of the present disclosure.

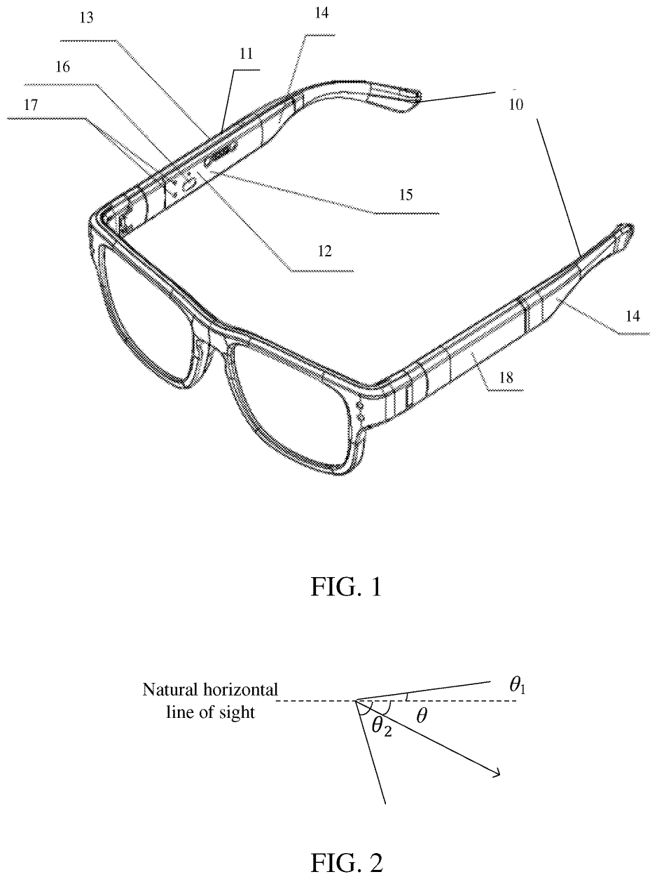

Referring to FIG. 1, FIG. 1 is a schematic diagram of a hardware structure of smart glasses according to an embodiment of the present disclosure. For ease of description, only parts related to the embodiments of the present disclosure are shown.

The smart glasses include: a processor 11, a sensor 12, an input device 13, and a playback device 14, all provided in temples 10.

The processor 11 is connected to the sensor 12, the input device 13, and the playback device 14.

The processor 11 is used to obtain sensing data from the sensor 12, and determine an eye-use state of a user according to the sensing data.

The eye-use state includes: a focused eye-use state, a static state, and a dynamic state.

The focused eye-use state refers to a continuous eye-use state such as when a user reads books or views electronic product screens, in which the user's head tilts up and down or swings left and right within a preset amplitude.

The static state refers to a state in which the amplitude of the user's head movement is small. The variation amplitude of the head movement is determined according to the absolute variations of acceleration and angular velocity. When the variation amplitude of the user's head movement is less than a variation amplitude threshold of the head movement during the user's normal walking, it is determined that the user is in the static state. The static state includes the focused eye-use state, such as riding in a vehicle, chatting, attending a meeting, eating, reading, using a mobile phone, and so on.

The dynamic state refers to a state in which the amplitude of the user's head movement is large. The variation amplitude of head movement is determined according to the absolute variations of acceleration and angular velocity. When the variation amplitude of the user's head movement is greater than the variation amplitude threshold of the head movement during the user's normal walking, it is determined that the user is in the dynamic state, such as running, walking, or going up and down stairs.

The processor 11 is further used to control the playback device 14 to issue a rest notification in response to the eye-use state of the user satisfying a preset notification condition.

The preset notification condition may include: a notification score corresponding to a continuous duration of the user in the focused eye-use state, or a notification score corresponding to a continuous duration of the user in the static state of a non-focused eye-use state, or a sum of the notification score corresponding to the continuous duration of the user in the focused eye-use state and the notification score corresponding to the continuous duration of the user in the static state of the non-focused eye-use state, being greater than a notification score threshold.

Specifically, the processor 11 is further used to: calculate a rest notification score threshold S_{remind}, according to a weighted score w corresponding to the eye-use state, and a preset rest notification interval T; and

calculate a rest notification score S according to the weighted score w corresponding to the eye-use state and activity time t of the user, and control the playback device to issue the rest notification in response to the rest notification score S being greater than the rest notification score threshold S_{remind}.

Specifically, the weighted score corresponding to the focused eye-use state is w₁, the weighted score corresponding to the static state is w₂, and the weighted score corresponding to the dynamic state is w₃;

w₁>w₂>w₃, for example, w₁=2,w₂=1,w₃=0.

The activity time of the user is denoted as t, and the rest notification score is denoted as S. Then:

$$S = w * t ;$$

wherein, when the user is in the focused eye-use state, w=w₁; when the user is in the static state of the non-focused eye-use state, w=w₂; and when the user is in the active state, w=w₃.

S_{remind} is the rest notification score threshold, S_{remind}=w₁*T, wherein T denotes the preset rest notification interval, and the unit thereof is seconds.

In general, when the preset rest notification interval T is 20 minutes, namely T=1200 seconds, the rest notification score threshold S_{remind}=2400.

In one example, when a user remains in the focused eye-use state for 20 consecutive minutes, S=2400; and the smart glasses issue a rest notification after 20 minutes.

In another example, when a user is in the static state of the non-focused eye-use state, such as attending a meeting for 20 consecutive minutes, S=1200, and no rest notification is issued. When the user conducts focused eye use for 10 minutes thereafter, or attends the meeting for another 20 minutes, S=2400, and the smart glasses issue the rest notification.

In another example, when the user remains in the focused eye-use state for 10 consecutive minutes, and then stays in the active state, such as walking for 2 consecutive minutes, S is reset to zero, and no rest notification is issued by the smart glasses.

In this embodiment, it is determined whether the user needs a rest notification not only based on the focused eye-use state, but also comprehensively based on the eye-use state and the eye-use duration of the user.

The processor 11 is further used to, in response to a preset input action performed by the user on the input device 13 being detected within a preset waiting duration, play a preset audio file through the playback device 14.

The input device 13 includes a touch device, and correspondingly, the preset input action is a touch action. The input device 13 further includes one or more buttons, and correspondingly, the preset input action is an action of pressing the one or more buttons.

When the user performs the input action on the input device 13, the input device 13 sends a notification signal, so that the processor 11 can obtain the notification signal and thereby determine that the input action is performed on the input device 13.

The playback device 14 may specifically be one or more speakers.

A first wireless data transmission component 15 is further provided in the temple 10 of the smart glasses, and is used for the wireless connection between the smart glasses and a smart terminal provided with a second wireless data transmission component. The smart terminal may be an electronic device such as a mobile phone, a smart watch, a tablet computer or a desktop computer.

The processor 11 is further used to: obtain, through the first wireless data transmission component 15, the duration of the user using the screen of the smart terminal, or obtain a heartbeat count of the user; and in response to the duration exceeding a preset usage duration, or an average heartbeat rate of the user within a preset time period exceeding a preset heartbeat rate, determine that the user needs to rest, and control the playback device 14 to issue the rest notification.

The user may set, through an application program running on the smart terminal, the sound file corresponding to the rest notification issued by the smart glasses. The sound file may be a soft voice notification with notification content such as “Please take a rest” and “You have used your eyes for 20 minutes, please take a rest”, or a music sound, such as piano music and singing bowl audio. The user may further set the rest notification interval corresponding to the continuous focused eye-use state, wherein the rest notification interval is generally set to 20 minutes, and may also be 30 minutes, 40 minutes and the like. In addition, the user may further set the volume of the rest notification.

The user may further use the application program to set the audio file played by the smart glasses after detecting that the user performs the preset input action on the input device 13. Specifically, the playback is performed in accordance with the playback date, playback time period, and playback volume selected and set by the user. The playback date may be Monday to Friday; the playback time period may be from 9 a.m. to 10 p.m. each day within the foregoing playback dates. Outside the playback dates and playback time periods, no audio file can be played even if the user performs the preset input action on the input device 13.

The user may further set the types of audio files to be played through the application program. A music library is built in the application program. Each audio file in the music library is classified by music category and music effect. The user may select a certain type of music according to personal preferences, such as soothing music, or choose a type of sound effect, such as water drop sounds, rain sounds and the like.

The processor 11 is further used to: obtain and store, through the first wireless data transmission component 15, the preset dynamic statistical duration, the sound file of the rest notification, and the notification volume of the rest notification, all of which are set by the user on the smart terminal.

The processor 11 is further used to obtain and store, through the first wireless data transmission component 15, playback dates, playback time periods and playback volumes of a plurality of preset audio files, which are set by the user on the smart terminal.

The processor 11 is further used to obtain and store, through the first wireless data transmission component 15, types of the preset audio files set by the user on the smart terminal.

After the processor 11 obtains the aforementioned parameters set on the smart terminal, the processor 11 may store the aforementioned parameters. When the smart glasses are not connected to the smart terminal, the processor 11 may further perform the following operations according to the above parameters: controlling the playback device 14 to issue a rest notification when the eye-use state of the user satisfies a preset notification condition, and controlling the playback device 14 to play preset audio files when it is detected that the user performs a preset input action on the input device 13 within a preset waiting duration.

Specifically, the processor 11 is further used to, when a count of preset input actions performed by the user on the input device 13 is detected to reach a preset action count within the preset waiting duration, search for an audio file with a playback date and a playback time period respectively corresponding to the current date and the current time among a plurality of preset audio files, and control the playback device 14 to play the searched audio file. The preset waiting duration is a short waiting duration, such as one minute. When a preset input action on the input device 13 is detected within the preset waiting duration, it is determined that the user performs an action for triggering playback of audio files.

The preset action count is, for example, one time, two times or multiple times, and may be arbitrarily set by the user.

The user may preset a plurality of audio files, and different audio files are played in different playback time periods. For example, forest background sound effects are played from 9 a.m. to 12 p.m., sound guidance for stretching and tendon-relaxing exercises is played from 2 p.m. to 8 p.m., and hypnotic music is played from 9 p.m. to 10 p.m.

Further, the sensor 12 includes an inertial sensor, which specifically includes a three-dimensional acceleration sensor and a three-dimensional gyroscope. The sensing data includes acceleration and angular velocity.

The processor 11 is further used to: calculate a variation of the acceleration and a variation of the angular velocity, calculate a head angle of the user according to the acceleration, and determine whether the variation of the acceleration and the variation of the angular velocity satisfy a preset focused eye-use condition, a preset static state condition or a preset dynamic state condition;

in response to the preset focused eye-use condition being satisfied, determine that the user is in a focused eye-use state according to the head angle of the user;

in response to the preset static state condition being satisfied, determine that the user is in a static state; and

in response to the preset dynamic state condition being satisfied, determine that the user is in a dynamic state.

Further, a cumulative duration of the user in the focused eye-use state is continuously counted. The processor 11 is further used to, in response to the duration of the user continuously staying in a dynamic state reaching a preset statistical duration, reset the cumulative timing of the focused eye-use state of the user.

Specifically, the calculation method is to calculate an absolute variation |Δₐ| of the acceleration, or an absolute variation |Δ_{ω}| of the angular velocity:

$$\vert {Δ}_{a} \vert = {\sum }_{i = 0}^{2} {\sum }_{t = 0}^{N - 1} \vert {a}_{i} ( t + 1 ) - {a}_{i} ( t ) \vert ;$$

$$\vert {Δ}_{ω} \vert = {\sum }_{i = 0}^{2} {\sum }_{t = 0}^{N - 1} \vert {ω}_{i} ( t + 1 ) - {ω}_{i} ( t ) \vert ;$$

where, aᵢ denotes the acceleration of the user's head, and ωᵢ denotes the angular velocity of the user's head;
i is a dimension of the three-axis accelerometer and the three-axis gyroscope, and numbers 0, 1 and 2 in formulas correspond to X axis, Y axis and Z axis respectively; t is the number of data samples collected in each sampling period; N is the total amount of sensing data within each sampling period; and a sampling period can be 1 second, 2 seconds, 5 seconds and the like.

When |Δₐ|<|Δ_{aw}|, it is determined that the static state condition is satisfied and the user is in the static state; otherwise, it is determined that the dynamic state condition is satisfied and the user is in the dynamic state; wherein |Δ_{aw}| is the variation amplitude threshold of acceleration during normal walking of the user, and is a known value.

Alternatively, when |Δ_{ω}|<|Δ_{ωw}|, it is determined that the static state condition is satisfied and the user is in the static state; otherwise, it is determined that the dynamic state condition is satisfied and the user is in the dynamic state; wherein |Δ_{ωw}| is the variation amplitude threshold of angular velocity during normal walking of the user, and is a known value.

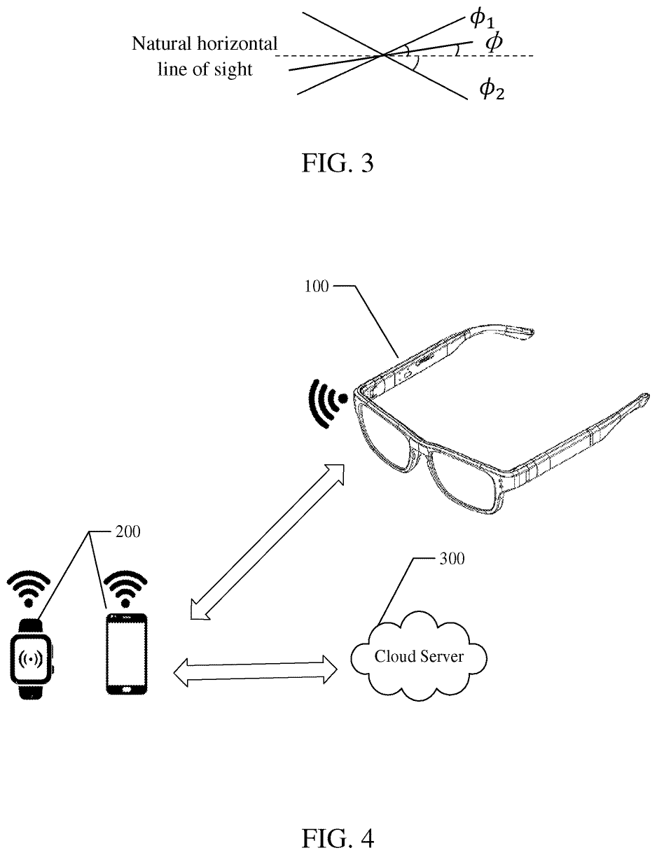

When the calculated |Δₐ| and |Δ_{ω}| satisfy the static state condition, the head angle of the user is calculated according to sensing data of the acceleration sensor, so as to determine whether the user satisfies a preset focused eye-use condition. Referring to FIGS. 2 and 3, FIG. 2 is a schematic diagram of a sagittal plane of the user's line of sight, FIG. 3 is a schematic diagram of a coronal plane of the user's line of sight, and the natural horizontal line of sight refers to a direction when the user looks straight ahead:

$$θ = {tan}^{- 1} \frac{{a}_{y}}{{a}_{z}} ; ϕ = {tan}^{- 1} \frac{{a}_{x}}{{a}_{z}} ;$$

where, θ₁, θ, and θ₂ may denote pitch angles of the user's head, θ denotes the pitch angle of the user's head, θ₁ and θ₂ respectively denote the maximum allowable pitch angles in the focused eye-use state; and the value of θ is generally within a range from 10° to 50°;
φ₁, φ, and φ₂ may denote roll angles of the user's head, φ denotes the roll angle of the user's head, φ₁ and φ₂ respectively denote the maximum allowable roll angles in the focused eye-use state; and the value of φ is generally within a range from −30° to 30°; and
aₓ, a_{y} and a_{z} respectively denote the acceleration components of the user's head on the X, Y and Z axes.

When the calculation results meet θ₁≤θ≤θ₂ and φ₁≤φ≤φ₂, it is determined that the user is in the focused eye-use state.

Further, the smart glasses further include a proximity sensor 16, one or more microphones 17 and a battery 18.

In embodiments of the present disclosure, the smart glasses in the present disclosure include the processor, the sensor, an input device and the playback device, all of which are provided in the temples. The processor is used to continuously obtain sensing data of the sensor, determine an eye-use state of the user according to the sensing data, control the playback device to issue the rest notification in response to the eye-use state of the user satisfying the preset notification condition, and control the playback device to play the preset audio file in response to the preset input action performed by the user on the input device being detected within the preset waiting duration. Accordingly, the automatic triggering of the rest notification and playing of audio files upon detection of the user's input action can be realized by monitoring the user's eye-use state, and the intelligence of the smart glasses and the convenience of user operation are improved.

In addition, by obtaining the playback dates, playback time periods and file types for playing audio files set by a user in a smart terminal, and playing favorite music in accordance with working hours and daily routine of the user, the relaxation of eyes and spirit is achieved, so as to protect eyesight and relieve pressure.

Referring to FIG. 4, an embodiment of the present disclosure further provides a smart glasses system, which includes: smart glasses 100, a smart terminal 200 and a cloud server 300.

The smart glasses 100 are the smart glasses described in the foregoing embodiments, and the smart terminal 200 is the smart terminal described in the foregoing embodiments. Application programs run on the smart terminal 200, and the cloud server 300 can store data and application programs.

The smart glasses 100 are connected to the smart terminal 200 through a wireless network, and the smart terminal 200 is connected to the cloud server 300 through a wireless network or a mobile network.

The wireless network includes Bluetooth, WIFI and the like. The mobile network includes 4G, 5G and the like.

The smart glasses 100 obtain data of the application programs set by the user on the smart terminal 200 through the wireless network.

The smart terminal 200 exchanges data with the cloud server 300 through the wireless network, such as downloading application programs, and uploading the setting data of the smart glasses 100 to the cloud server 300.

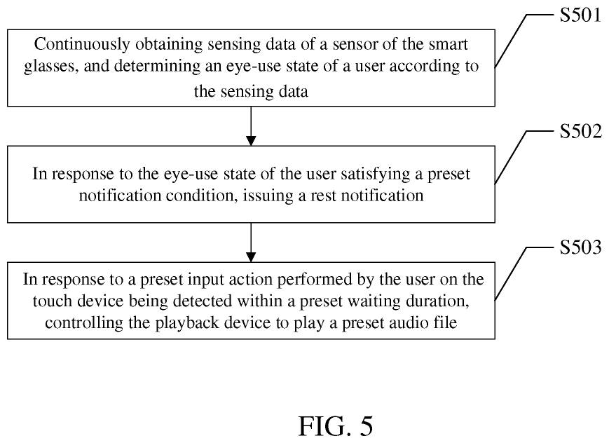

Referring to FIG. 5, an embodiment of the present disclosure further provides a stress relief notification method, and the method can be applied to the smart glasses in the foregoing embodiments. A rest notification is issued by the smart glasses, and when the smart glasses detect a preset input action of a user, a preset audio file is played. The method includes the following steps:
S501, continuously obtaining sensing data of a sensor of the smart glasses, and determining an eye-use state of a user according to the sensing data;
S502, in response to the eye-use state of the user satisfying a preset notification condition, issuing a rest notification; and
S503, in response to a preset input action performed by the user on the input device being detected within a preset waiting duration, controlling the playback device to play a preset audio file.

For specific details of the embodiments of the present disclosure, reference may be made to the descriptions of the foregoing embodiments.

In embodiments of the present disclosure, by continuously obtaining the sensing data of the sensor of the smart glasses, determining the eye-use state of the user according to the sensing data, controlling the playback device to issue the rest notification when the eye-use state of the user satisfies the preset notification condition, and controlling the playback device to play the preset audio file, the automatic triggering of the rest notification and the playing of audio files upon detection of the user's input action can be realized by monitoring the user's eye-use state, and the intelligence of the smart glasses and the convenience of user operation are improved.

It should be noted that, for the convenience of description, the foregoing method embodiments are described as a series of action combinations. However, those skilled in the art should understand that the present disclosure is not limited by the described sequence of actions, since, in accordance with the present disclosure, some steps may be performed in other orders or simultaneously. Furthermore, those skilled in the art should also understand that the embodiments described in the specification are all preferred embodiments, and the actions and modules involved are not necessarily essential to the present disclosure.

In the aforementioned embodiments, the description of each embodiment focuses on different aspects. For parts not elaborated in a certain embodiment, reference may be made to the relevant descriptions in other embodiments.

The aforementioned description of the smart glasses, smart glasses system and stress relief notification method provided by the present disclosure may be modified in terms of specific implementation manners and application scopes by those skilled in the art in accordance with the ideas of the embodiments of the present disclosure. In summary, the contents of this specification shall not be construed as limiting the present disclosure.

What is claimed is:

1. Smart glasses, comprising: a processor, a sensor, an input device and a playback device provided in temples;
wherein the processor is connected with the sensor, the input device and the playback device;
the processor is configured to continuously obtain sensing data of the sensor, and determine an eye-use state of a user according to the sensing data; and
the processor is further configured to, in response to the eye-use state of the user satisfying a preset notification condition, control the playback device to issue a rest notification, and in response to a preset input action performed by the user on the input device being detected within a preset waiting duration, control the playback device to play a preset audio file.

2. The smart glasses of claim 1, wherein the processor is further configured to, in response to a count of preset input actions performed by the user on the input device being detected to reach a preset action count within the preset waiting duration, search for an audio file with a playback date and a playback time period respectively corresponding to current date and current time among a plurality of preset audio files, and control the playback device to play the searched audio file.

3. The smart glasses of claim 2, wherein the sensor comprises an inertial sensor, and the sensing data comprises acceleration and angular velocity.

4. The smart glasses of claim 3, wherein the processor is further configured to:
calculate a variation of the acceleration and a variation of the angular velocity, calculate a variation amplitude of head movement of the user, and determine that the user is in a static state or a dynamic state according to the variation amplitude of head movement of the user; and
calculate a head angle of the user according to the acceleration, and determine that the user in the static state is in a focused eye-use state or in the static state of a non-focused eye-use state according to the head angle of the user.

5. The smart glasses of claim 4, wherein the processor is further configured to:
calculate a rest notification score threshold S_{remind}, according to a weighted score w₁ corresponding to the focused eye-use state, and a preset rest notification interval T;
calculate a rest notification score S according to the weighted score w₁ corresponding to the focused eye-use state and activity time t of the user; and
control the playback device to issue the rest notification in response to the rest notification score S being greater than the rest notification score threshold S_{remind}.

6. The smart glasses of claim 5, wherein the processor is further configured to reset the rest notification score S to zero after the user remains in the dynamic state for more than a preset dynamic statistical duration.

7. The smart glasses of claim 6, wherein the smart glasses further comprise a first wireless data transmission component; and
the first wireless data transmission component is configured to enable a wireless connection between the smart glasses and a smart terminal with a second wireless data transmission component.

8. The smart glasses of claim 7, wherein the processor is further configured to:
obtain, through the first wireless data transmission component, a duration of the user using a screen of the smart terminal, or obtain a heartbeat count of the user; and
in response to the duration exceeding a preset usage duration, or an average heartbeat rate of the user within a preset time period exceeding a preset heartbeat rate, control the playback device to issue the rest notification.

9. The smart glasses of claim 8, wherein the processor is further configured to obtain and store, through the first wireless data transmission component, a preset dynamic statistical duration, a sound file of the rest notification, and a notification volume of the rest notification, wherein the preset dynamic statistical duration, the sound file, and the notification volume are set by the user on the smart terminal.

10. The smart glasses of claim 9, wherein the processor is further configured to obtain and store, through the first wireless data transmission component, playback dates and playback time periods of the preset audio files set by the user on the smart terminal.

11. The smart glasses of claim 10, wherein the processor is further configured to obtain and store, through the first wireless data transmission component, types of the preset audio files set by the user on the smart terminal.

12. A smart glasses system, comprising a smart terminal, a cloud server, and the smart glasses of claim 1.

13. A stress relief notification method, applied to smart glasses, wherein the method comprises:
issuing the rest notification through the smart glasses of claim 1; and
playing the preset audio file through the smart glasses in response to the smart glasses detecting the preset input action of the user.
